(19) United States
(12) Patent Application Publication
(10) Pub. No.: US 2024/0317541 A1
(43) Pub. Date: Sep. 26, 2024

(54) REEL ARRANGEMENT

(71) Applicant: Stemmann-Technik GmbH, Schüttorf (DE)

(72) Inventors: Henning Bollen, Schüttorf (DE); DANIEL BOLLE, Samern (DE); THOMAS BRIESCHKE-GRONAU, Ibbenbüren (DE)

(73) Assignee: Stemmann-Technik GmbH, Schüttorf (DE)

(21) Appl. No.: 18/579,767

(22) PCT Filed: Sep. 14, 2022
(86) PCT No.: PCT/DE2022/100685

§ 371 Date: Jan. 16, 2024

(30) Foreign Application Priority Data
Sep. 15, 2021 (DE) 10 2021 123 843.9

(51) Int. Cl. B65H 75/44; B60L 53/18

(52) U.S. Cl. CPC B65H 75/4452; B60L 53/18

(57) ABSTRACT

A reel arrangement includes a main reel and a secondary reel which are mounted on a common reel axle. A winding diameter of the secondary reel is smaller than a winding diameter of the main reel. A line runs from a stationary first line end via a line loop to the secondary reel to be wound up and unwound there. The line is then routed to the main reel and secured to the main reel and/or the secondary reel. The secondary reel is winding spirally and the main reel is winding cylindrically. The line loop is under the influence of a tensioning force directed in opposition to a winding direction of the secondary reel and pulls on the line loop such as to always spirally wind the line. A weight body is connected to the line loop for displacement in longitudinal direction of the line to generate the tensioning force.

The invention relates to a reel arrangement according to the features of patent claim 1.

Reel arrangements for winding electrical lines are known, in which the electrical energy is transmitted to the rotating reel arrangement via slip rings. The slip ring bodies are oftentimes a limiting factor for the transmission of electrical power, in particular for charging electric vehicles of any type.

The invention is based on the object to provide a reel arrangement in which the limitation as a result of slip ring bodies is eliminated, in particular in order to transmit higher charging powers.

This object is attained by a reel arrangement with the features of patent claim 1.

The sub-claims relate to advantageous refinements of the invention.

The reel arrangement according to the invention completely dispenses with a slip ring arrangement. It involves a reel arrangement without slip ring. The reel arrangement includes a main reel and a secondary reel on a common reel axle. The main reel and the secondary reel are moved in synchronism, i.e. always in the same direction of rotation and at the same rotational speed. In particular, the main reel and the secondary reel are connected to one another.

The reel arrangement includes a line to be wound up. The line has a first fixed line end. Coming from there, the line first runs via a line loop to the secondary reel, where it is wound and unwound. The line is then routed to the main reel. It is fastened to the main reel and/or the secondary reel. The line can be wound and unwound over the main reel so that its free end can be connected to a connection, for example to an electric vehicle.

The reel arrangement is designed such that the secondary reel has a smaller winding diameter than the main reel. The reel arrangement according to the invention is used in such a way that the line is initially guided to the secondary reel without a slip ring and is wound up there from radial outside. The winding of the main reel and/or the secondary reel can be spiral or helical. A first length of line is wound onto the secondary reel. However, the winding diameter of the main reel, to which the same line is then routed, is greater than the winding diameter of the secondary reel. This means that for the same number of rotations of the reels, a greater length of line is wound on the main reel than on the secondary reel. Since the line length on the secondary reel is also limited by the fixed line loop, while the line loop is enlarged when the reels are unwound at the same time a significantly longer line portion is however unwound from the main reel.

Such a reel arrangement does not require any slip ring transmitter at all. The charging power is therefore not limited by slip ring bodies. The only limiting factor is the charging infrastructure and possibly the maximum line length that can be wound up. Although a certain length of line is required for the secondary reel, this length is, however, comparatively short in relation to the length of line that can be unwound from the main reel, especially when great differences in the winding diameters are involved. A further advantage of the reel arrangement according to the Invention is that a uniform line can be used from one end to the other end of the line to be wound on the reel arrangement. No interfaces between the rotating reel and a stationary installation are necessary.

In an advantageous refinement of the invention, the secondary reel is designed to be spirally winding and the main reel is designed to be cylindrically winding. A spirally winding secondary reel has in axial direction a very small width, . . . which is only slightly greater than the diameter of the line. Such a secondary reel can be arranged directly next to the main reel in a markedly space-saving manner. As the main reel has a greater winding diameter anyway, the greater diameter of the end reel wall can also be used as a reel wall for the secondary reel. The two reels are therefore preferably arranged directly side-by-side. In particular, the secondary reel is directly connected to the main reel. This also has the advantage that only a short line length is required to guide the line from the secondary reel to the main reel. The line is accommodated radially inside the reel body of the secondary reel and is routed from there to the main reel, where it is guided in a cylindrical winding in particular.

For a reliable winding process, the line loop can be under the influence of a tensioning force that is directed against the winding direction of the secondary reel. In other words, the tensioning force pulls on the line loop in such a way that the line is always properly spirally wound. The tensioning force can be a spring force, so that the orientation of the line loop can be randomly selected. Particularly beneficial solutions can be realized when the line loop is under the influence of a gravity-based tensioning force. It is emphasized that such a gravity-based tensioning force can also be deflected in any direction via a pulling mechanism. Preferred, however, is a pulling of the line loop directly vertically downwards, in particular by a weight body that is suspended from the line loop. Such a weight body is connected to the line loop preferably for movement in longitudinal direction of the line. This may involve a roller block that rolls over the line and always hangs at the lowest point of the line loop.

The reel arrangement according to the invention is preferably designed such that a line portion on the secondary reel has a smaller winding length than a line portion on the main reel, so that when the main reel is unwound in a first direction of rotation, the winding direction on the secondary reel is reversed. The reel arrangement is therefore used in particular in such a way that both the line from the main reel and the line from the secondary reel are unwound for unwinding in a first direction of rotation, e.g. counterclockwise. The unwound line portions are . . . respectively located on the side of the two reels facing in the direction of rotation. When the shorter line portion on the secondary reel has now been completely unwound and both reels are moved further, the line portion that is connected to the secondary reel is pulled to the other side, so that the line on the secondary reel no longer unwinds but winds up again while the direction of rotation remains the same. There are therefore two winding phases on the secondary reel when unwinding the main reel only, namely a first phase in which the secondary reel is also unwound and then a second phase in which the line is wound up again onto the secondary reel. This winding process can only be continued until the line loop has reached its shortest length. Preferably, the winding diameters of the main reel and the secondary reel are matched to each other in such a way that when the main reel is fully wound and when the secondary reel is fully unwound, the line portion on the secondary reel is fully wound up. The difference is, however, that the second winding phase must run through last in order to reach the fully unwound main reel and the first winding phase of the secondary reel-side winding process must run through last in order to reach the fully wound main reel.

In particular, the reel arrangement is provided with a drive which is connected to the main reel and/or the secondary reel and drives the respective other reel via the one reel. The drive is designed to rotate the main reel and the secondary reel simultaneously. In particular, it may involve an internal drive within the reel arrangement, with sufficient installation space being available to accommodate a drive, especially within the main reel due to the great winding diameter. The drive is mounted on a fixed axle. As mentioned above, it is particularly suitable to arrange the main reel and the secondary reel directly side-by-side and also to connect them directly to one another so that the drive force is transmitted from one reel to the other.

The line is used in particular to transmit electrical energy to a mobile consumer. In particular, the reel arrangement includes a suspension which is designed in such a way that the reel arrangement can preferably be suspended above a mobile consumer in order to enable a lowering of a line end coming from above to the consumer. High-hanging reel arrangements make it possible to keep interfering line ends away from the ground. This prevents plugs from being driven over and damaged and makes maneuvering easier. In addition, the line portion of the line loop can be guided freely downwards. The reel arrangement according to the invention is therefore preferably located at a height at which the line loop can hang freely downwards.

The reel arrangement is not limited to a specific type of line. A line within the meaning of the invention can be designed for transmission of energy and/or signals and/or fluids, e.g. gases, liquids, flowable solids and/or mixtures of fluids and/or solids. Hybrid lines are also possible, which have several lines for different purposes, for example a data line and a line for energy transmission. Several lines can also be connected together to form a line within the meaning of the invention, for example a pair of lines that as such can also be visually recognized as a pair of lines. The term line does not necessarily mean that a certain substance must be conducted from one end to the other end in order to exit the line again. It can also involve cooled lines in which, for example, a coolant cools an electrical conductor and enters as well as exits at the beginning of the line.

The reel arrangements according to the invention can be used anywhere where a brief sagging of the connecting line or line loop poses no problem. A possible area of application would be, for example, reel arrangements for special types of communication, including winding a fiber optic cable. Such a reel arrangement is preferably used for electric lines for charging an electric vehicle.

The invention is explained hereinafter with reference to drawings. The drawings are purely schematic and not to scale. They are intended only to illustrate the principle of operation. It is shown in:

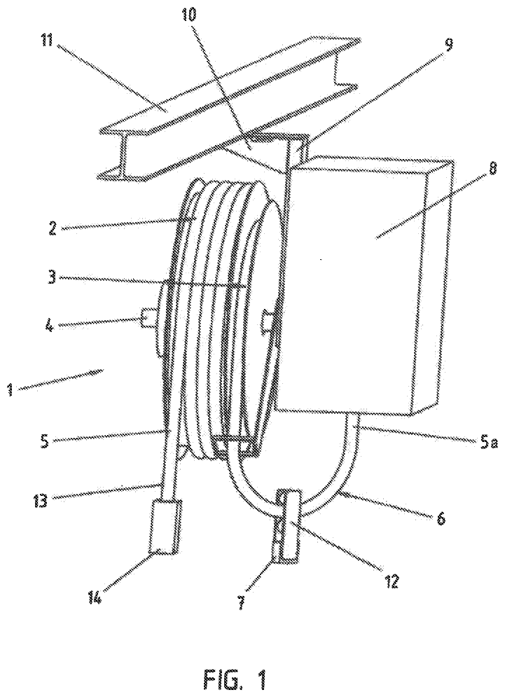

FIG. 1 a perspective view of a reel arrangement;

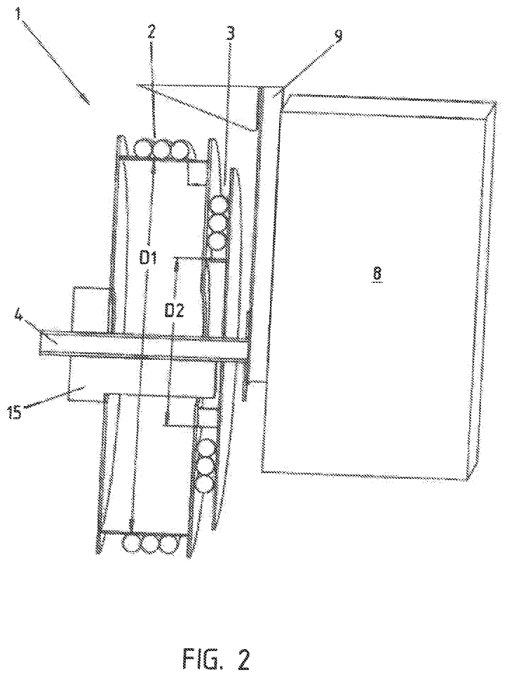

FIG. 2 a cross-section of the reel arrangement of FIG. 1;

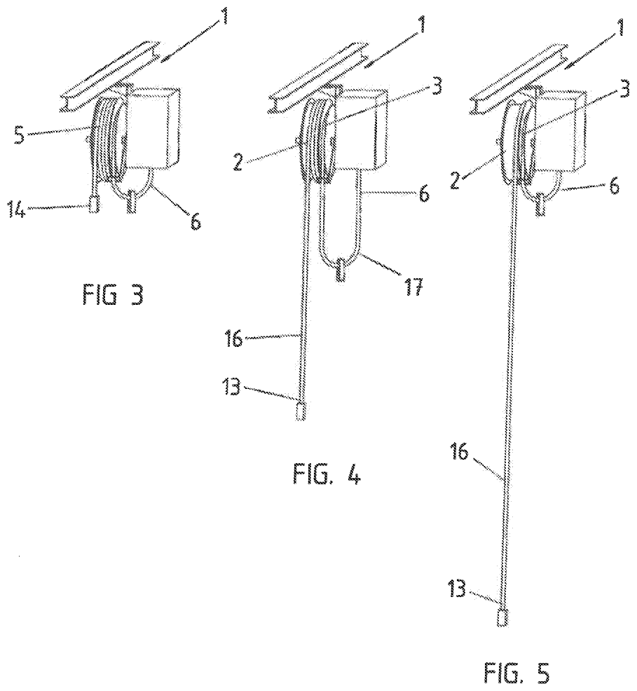

FIG. 3 the reel arrangement of FIG. 1 from a different perspective;

FIG. 4 the reel arrangement of FIG. 3 during unwinding;

FIG. 5 the reel arrangement of FIG. 3 in the unwound state;

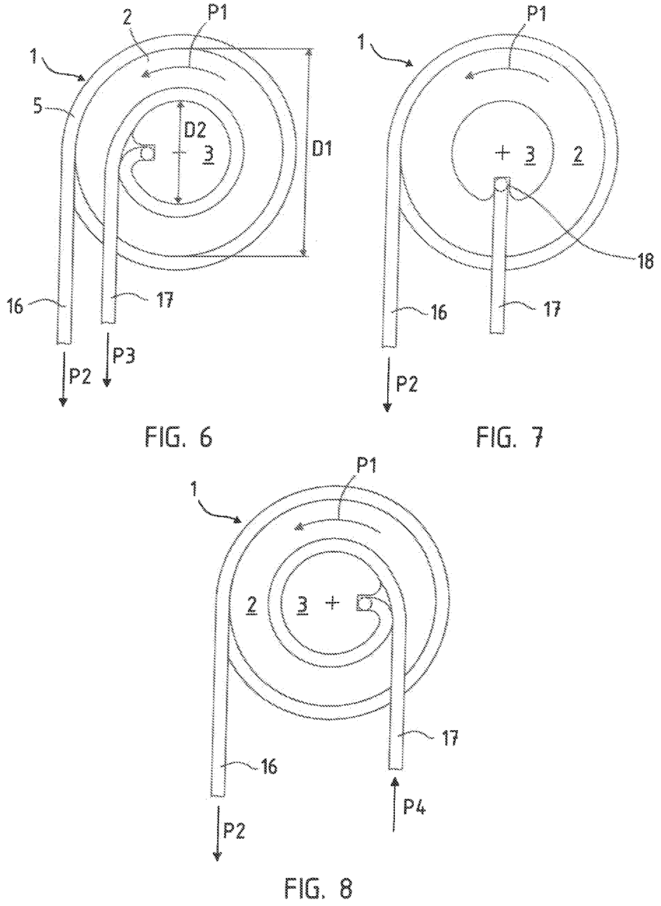

FIG. 6 a cross-section through the reel arrangement of FIG. 1 in a first winding phase;

FIG. 7 the reel arrangement of FIG. 6 in the transition from the first to the second winding phase; and

FIG. 8 the reel arrangement of FIG. 6 in a second winding phase.

FIG. 1 shows a reel arrangement 1 with a main reel 2 and a secondary reel 3. The main reel 2 and the secondary reel 3 are connected to one another and mounted on a common reel axle 4. The reel axle 4 is arranged horizontally. The reel arrangement 1 carries a line 5 to be wound up, which involves an electrical line for charging a motor vehicle. The line includes a line loop 6 with a stationary first line end 7, which feeds into a connection box 8 adjacent to the secondary reel 3. The connection box 8 and the reel axle 4 are connected to a suspension 9, which is arranged between the connection box 8 and the reel axle 4. Above the reel arrangement 1, the suspension 9 has a horizontal support arm 10, which is connected to a horizontal support 11. The support arm 10 can be fixedly . . . connected to the horizontal support 11. It is possible to arrange the support arm 10 for movement in longitudinal direction of the horizontal support 11 in order to bring the reel arrangement 1 into the desired position.

The line loop 6 hangs downwards and is pulled downwards by the weight body 7. When the line loop 6 is extended, the weight body 7 is moved to a different position, i.e. always to the lowest point of the line loop 6. This is ensured by a roller block 12, which, on one hand, carries the weight body 7 and, on the other hand, rolls in longitudinal direction on the line loop 6. The line 5 extends from the first line end 7 via the line loop 6 initially to the secondary reel 3 and via a radially inner path from the secondary reel 3 to the main reel 4 up to the second line end 13 with a plug 14. The functional principle is explained hereinafter.

FIG. 2 shows a longitudinal section through the reel arrangement of FIG. 1 in the area of the reel axle 4. The secondary reel 3 takes up the line 5 in a spiral winding. The line 5 is then routed to the cylindrically winding main reel 2. A drive 15 is secured to the reel axle 4 and is used to set the reel arrangement 1 in motion. This involves an electric drive, via which the main reel 2 and the secondary reel 3 are supported.

It is essential for the invention that the main reel 2 has a winding diameter D1 which is greater than the winding diameter D2 of the secondary reel 3. Although due to the spiral winding the winding diameter D2 of the secondary reel 3 becomes greater as the number of windings increases, it is in no case as great as the winding diameter D1 of the main reel 2. This means that as the main reel 2 rotates, a greater line portion is always unwound than from the secondary reel 3. This principle is explained hereinafter with reference to FIGS. 3 to 8.

FIG. 3 shows the starting position as is shown in FIGS. 1 and 2. The line 5 is completely wound up. The line loop 6 is as short as possible. The plug 14 is in its upper end position.

The drive 15 is now actuated and turns the reel arrangement 1 counterclockwise so that a line portion 16 is unwound from the main reel 2. At the same time, the line loop 6 is extended because the secondary reel 3 is also unwound. The line portion 17, which was unwound from the secondary reel 3, is shorter than the line portion 16 from the main reel 3 due to the smaller winding diameter D2.

When the second line end 13 is now unwound further (FIG. 5) until reaching the end position shown there, the line loop 6 is shortened again to its original line length. This is due to the fact that the line portion 17 on the secondary reel 3 has a shorter winding length than the line portion 16 on the main reel 2. As a result, when the main reel 2 is unwound in a first direction of rotation, the winding direction on the secondary reel 3 is reversed from a certain point on. FIGS. 6 to 8 illustrate this principle.

FIG. 6 is a highly simplified side illustration of the reel arrangement 1. The secondary reel 3 is facing the observer, the main reel is situated behind it. The secondary reel 3 has the smaller winding diameter D2. The main reel 2 has the greater winding diameter D1.

The line 5 is unwound counterclockwise from the main reel 2 in the direction of rotation of arrow P1. Arrow P2 shows how the line end 16 of line 5 is unwound downwards. At the same time, the line portion 17 of the secondary reel 3 is also unwound. The arrow P3 on the line portion 17 points in the same direction as the arrow P2.

FIG. 7 shows a position of the secondary reel 3 in which a radially inner line connection 18, which is arranged on the secondary reel 3, points radially downwards. In this position, the line 5 or the line portion 17 is not wound onto the secondary reel 3. The loop, which includes the line portion 17, has its maximum length. In this position, the first winding phase of the secondary reel 3 is completed. After this reversal point, the second winding phase begins, as shown in FIG. 8. The reel arrangement 1 is further rotated in the direction of arrow P1 so that the line connection 18 is shifted to the right in the image plane and the line portion 17 is now wound or has been wound in the opposite direction to the line portion 16. The arrow P4, which indicates the direction of movement of the line portion 17, points accordingly towards the reel arrangement 1 and not, like the arrow P3 in FIG. 6, away from the reel arrangement 1. The line portion 16 of the main reel 2 continues to be unwound, while the line portion 17 of the secondary reel 3 is wound up until the position shown in FIG. 5 is reached.

Winding of the main reel 2 is implemented accordingly in the reverse sequence. The directions of all arrows in FIGS. 6 to 8 are reversed accordingly.

### REFERENCE SIGNS

1—reel arrangement
2—main reel
3—secondary reel
4—reel axle
5—line
6—line loop
7—first line end
8—connection box
9—suspension
10—support arm
11—horizontal support
12—roller block
13—second line end
14—plug
15—drive
16—line portion of the main reel
17—line portion of the secondary reel
18—line connection
D1 winding diameter of the main reel
D2 winding diameter of the secondary reel
P1 direction of rotation
P2 direction of movement of 16
P3 direction of movement of 17
P4 direction of movement of 17

1.-13. (canceled)

14. A reel arrangement, comprising:
a main reel mounted on a reel axle and defined by a winding diameter;
a secondary reel mounted on the reel axle and defined by a winding diameter which is smaller than the winding diameter of the main reel;
a line running from a stationary first line end via a line loop to the secondary reel in order to be wound up and unwound there, the line being then routed to the main reel and secured to at least one of the main reel and the secondary reel, wherein the secondary reel is winding spirally and the main reel is winding cylindrically, wherein the line loop is under the influence of a tensioning force which is directed in opposition to a winding direction of the secondary reel and pulls on the line loop such as to spirally wind the line at all times; and
a weight body connected to the line loop for displacement in a longitudinal direction of the line in order to generate the tensioning force.

15. The reel arrangement of claim 14, wherein the secondary reel includes a line portion which has a winding length which is smaller than a winding length of a line portion on the main reel, so that as the main reel is unwound in a first direction of rotation, the winding direction on the secondary reel reverses.

16. The reel arrangement of claim 15, wherein the winding diameter of the main reel and the winding diameter of the secondary reel are selected in such a . . . way that when the main reel is completely wound up and when the main reel is completely unwound, the line portion of the secondary reel is completely wound up in each case.

17. The reel arrangement of claim 14, further comprising a drive connected to at least one of the main reel and the secondary reel and designed to rotate the main reel and the secondary reel.

18. The reel arrangement of claim 14, wherein the secondary reel and the main reel are arranged directly next to one another.

19. The reel arrangement of claim 14, wherein the line is designed to transmit electrical energy to a mobile consumer.

20. The reel arrangement of claim 14, further comprising a suspension designed to suspend the reel arrangement above a mobile consumer so as to enable a line end of the line to be lowered from above to the consumer.

21. The reel arrangement of claim 14, wherein the line is designed for conduction of energy and/or a signal and/or a fluid, with the fluid being selected from the group consisting of gas, liquid, flowable solid and any combination thereof.

22. The reel arrangement of claim 14, wherein the line is a hybrid line with several line portions for different line purposes.

23. The reel arrangement of claim 14, for use in an electric line for charging an electric vehicle.
